(19) United States
(12) Patent Application Publication
(10) Pub. No.: US 2005/0148677 A1
(43) Pub. Date: Jul. 7, 2005

(54) Low K-factor rigid foam systems

(76) Inventors: Kevin J. Elsken, Canonsburg, PA (US); Steven L. Schilling, Pittsburgh, PA (US); Herman P. Doerge, Sedona, AZ (US)

Correspondence Address: BAYER MATERIAL SCIENCE LLC, 100 BAYER ROAD, PITTSBURGH, PA, 15205, US

(21) Appl. No.: 10/749,027

(22) Filed: Dec. 30, 2003

(51) Int. Cl. C08J 9/00

(52) U.S. Cl. 521/155

(57) ABSTRACT

The present invention provides rigid polyurethane foams prepared by mixing an isocyanate with a polyol component containing an aromatic amine-initiated polyether polyol, an aromatic polyester polyol and optionally, a sucrose-based polyether polyol. The inventive foams have good properties as indicated by an initial k-factor at 35° F. of from about 0.115 to about 0.120 BTU-in./hr.ft²° F. and may find use as insulation materials in the construction and refrigeration industries.

### FIELD OF THE INVENTION

The present invention relates in general to polyurethane foams and more specifically to rigid polyurethane foams having a low k-factor.

### BACKGROUND OF THE INVENTION

Processes for the production of rigid polyurethane foams are known. Doerge et al., in U.S. Pat. No. 5,539,006, teach rigid polyurethane foams produced by reacting an organic polyisocyanate with a sucrose-based polyether polyol in the presence of a catalyst and a blowing agent selected from hydrogen-containing chlorofluorocarbons (HCFCs), hydrogen-containing fluorocarbons (HFCs), hydrocarbons (HCs) and mixtures thereof. The examples of the '006 patent use HFC-356, HCFC-123 and HCFC-141b as blowing agents and although the patent states that other polyols may be used, it provides no guidance as to the selection of those other polyols.

U.S. Pat. No. 5,461,084 discloses rigid foams with good k-factors produced with an amine-initiated polyether polyol, water and an HFC. The '084 patent also teaches that it is advantageous to use a polyester polyol in combination with some amine-initiated polyols. The examples of the '084 patent use only aliphatic amine polyols with HFC-356 as the blowing agent.

Sucrose-based polyols are of particular interest as a part of the isocyanate-reactive reactant because of their relatively low cost, high functionality and relative simplicity of production. Processes for producing such sucrose-based polyols are disclosed, for example, in U.S. Pat. Nos. 3,085,085; 3,153,002; 3,222,357; and 4,430,490. Each of those patents teaches that the disclosed polyols are useful in the production of polyurethane foams.

U.S. Pat. Nos. 5,648,019; 5,677,359; and 5,648,057 all teach the use of three component polyol blends for use in insulating rigid foams. These blends require two different types of amine-initiated polyols (i.e., an aromatic amine-initiated polyol and an aliphatic amine-initiated polyol) and an aromatic polyester polyol. Sucrose-based polyether polyols are among the materials listed as optional components.

Singh et al., in U.S. Pat. No. 6,372,811, disclose flame-resistant, rigid polyurethane foams blown with HFCs. The '811 patent teaches that use of a polyol component which includes at least 40% of a polyester polyol and an organo-phosphorus compound produces rigid foams with good properties.

However, despite the efforts summarized above, a need continues to exist in the art for rigid polyurethane foams which can be made from lower cost reactants but which will retain good properties such as a low k-factor.

### SUMMARY OF THE INVENTION

Accordingly, the present invention provides a rigid polyurethane foam prepared by mixing an isocyanate with a polyol blend containing an aromatic amine-initiated polyol, an aromatic polyester polyol and optionally, a sucrose-based polyether polyol. The foams are blown with HCF-245fa and CO₂ from the reaction of isocyanate groups with water. The foams of the present invention have an initial k-factor at 35° F. of from about 0.115 to about 0.120 BTU-in./hr.ft²° F. and are particularly suitable as insulation materials in the construction and refrigeration industries.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, hydroxyl numbers, functionalities and so forth in the specification are to be understood as being modified in all instances by the term “about.” The molecular weights and equivalent weights given herein in Da (Daltons) are number average molecular weights and number average equivalent weights, respectively, unless specified otherwise. All k-factors are initial k-factors, i.e., measured within 24 hours of the time the foam was prepared.

The present invention provides a rigid polyurethane foam prepared by mixing an isocyanate component, a polyol blend containing from 20% to 100% of an aromatic amine-initiated polyether polyol, up to 60% of an aromatic polyester polyol, and up to 20% of a sucrose-based polyether polyol, 10 to 15% of 1,1,1,3,3-pentafluoropropane (HFC-245fa) based on the total foam formulation, water and optionally, one or more components chosen from catalysts, chain extenders, crosslinking agents, surfactants, foam stabilizers, cell regulators, fillers, dyes, pigments, flame retardants, hydrolysis protection agents, fungicides and bactericides. The rigid polyurethane foam has a k-factor of from 0.115 to 0.120 BTU-in./hr.ft²° F. at 35° F.

The present invention also provides a rigid polyurethane foam prepared by mixing an isocyanate component, a polyol blend containing from 40 to 90% of an aromatic amine-initiated polyether polyol, and 60 to 10% of an aromatic polyester polyol, 10 to 15% of 1,1,1,3,3-pentafluoropropane (HFC-245fa) based on the total foam formulation, water and optionally, one or more components chosen from catalysts, chain extenders, crosslinking agents, surfactants, foam stabilizers, cell regulators, fillers, dyes, pigments, flame retardants, hydrolysis protection agents, fungicides and bactericides. The rigid polyurethane foam has a k-factor of from 0.115 to 0.120 BTU-in./hr.ft²° F. at 35° F.

Polyol Blend

The inventive rigid polyurethane foams utilize an innovative polyol blend containing an aromatic amine-initiated polyether polyol, an aromatic polyester polyol, and optionally, a sucrose-based polyether polyol.

Aromatic Amine-Initiated Polyether Polyol

Examples of suitable amines that may be used to prepare the amine-initiated polyether polyols include, but are not limited to, 2,4′-, 2,2′-, and 4,4′-methylene dianiline, 2,6- or 2,4-toluene diamine and vicinal toluene diamines, p-aminoaniline and 1,5-diaminonaphthalene. Toluene diamines, especially ortho-toluene diamine (o-TDA), and a mixture of primarily 2,3-toluene diamine and 3,4-toluene diamine are particularly preferred.

The amine-initiated polyether polyols may be produced by any of the known methods such as by alkoxylating the amine initiator, either with or without an alkaline catalyst, until the desired hydroxyl number has been attained. Suitable alkoxylating agents include any of the known alkylene oxides such as ethylene oxide, propylene oxide, butylene oxide, amylene oxide, and mixtures thereof. Ethylene oxide and propylene oxide are preferred.

The aromatic amine-initiated polyether polyol may be present in an amount of from 20 to 100% of the polyol blend of the present invention, more preferably from 20 to 90%, based on the polyol blend, and preferably has a hydroxyl number of from 300 to 500 and a functionality of from 2 to 6. Preferred amine initiated polyether polyols are prepared from an aromatic diamine and have a nominal functionality of 4.

Aromatic Polyester Polyol

The aromatic polyester polyol useful in the polyol blend of the present invention is a reaction product of a polyhydric alcohol, preferably a dihydric alcohol and/or a trihydric alcohol with a polybasic, preferably dibasic polycarboxylic acid having an aromatic ring. As used herein, the term “aromatic polyester polyol” is intended to mean a polyhydroxy organic compound having aromatic rings joined to aliphatic hydrocarbons or ethers via ester linkages and ending in aliphatic hydroxyl groups.

To form a polyester polyol, a corresponding aromatic polycarboxylic anhydride or a corresponding aromatic polycarboxylate ester of a lower alcohol or a mixture thereof can be used in place of a free aromatic polycarboxylic acid. The polycarboxylic acid may be any aromatic polycarboxylic acid and it may be an aromatic polycarboxylic acid substituted with a halogen atom.

Examples of the polycarboxylic acid include phthalic acid including pure ortho-phthalic acid and phthalic anhydride, isophthalic acid, terephthalic acid, trimellitic acid, pyromellitic acid, anhydrous phthalic acid and derivatives thereof. Polycarboxylic acids containing phthalic acid or phthalic anhydride are preferred.

The polyhydric alcohol is preferably an alcohol having 2 to 9 carbon atoms, and may be any one of a straight chain, branched or cyclic alcohol. The polyhydric alcohol is preferably a dihydric alcohol and/or a trihydric alcohol. Examples of dihydric alcohols include ethylene glycol, diethylene glycol, propylene glycol, butanediol, pentanediol, hexanediol, cyclohexanediol and the like. Examples of trihydric alcohols include glycerine, trimethylolpropane and the like. Those prepared by decomposing polyethylene terephthalate with various glycols may also be used.

The aromatic polyester polyol may be present in the polyol blend in an amount of up to 60%, more preferably 5 to 60%, based on the polyol blend. The aromatic polyester polyol preferably has a hydroxyl number of from 150 to 400 and a functionality of from 2 to 3. Examples of suitable aromatic polyester polyols include those marketed by Stepan Corp. under the STEPANPOL trade name, those marketed by Kosa under the TERATE trade name and those marketed by Oxid under the TEROL trade name.

Sucrose-Based Polyether Polyol

The sucrose-based polyether polyol in the inventive blend is preferably prepared by reacting sucrose and optionally other initiators (with or without water) with ethylene oxide (EO) or propylene oxide (PO) or both EO and PO; in the presence of an alkaline catalyst. The reaction product may then be treated with an acid, preferably a hydroxy-carboxylic acid so as to neutralize the alkaline catalyst. U.S. Pat. No. 4,430,490 discloses one such suitable process.

It is preferred that the sucrose first be reacted with ethylene oxide and then propylene oxide. The ethylene oxide is used in an amount of from 10 to 50%, more preferably from 20 to 40% by weight of the total alkylene oxide used. The propylene oxide is used in an amount of from 50 to 90% by weight of the total alkylene oxide employed, more preferably from 60 to 80% by weight. The total amount of alkylene oxide used is selected so that the product polyol will have an average molecular weight of from 300 to 1600, more preferably from 440 to 1000.

The acid used to neutralize the alkaline catalyst present in the polyether polyol may be any acid that will result in an acidified polyether polyol having a pH of from 4.0 to 8.0, preferably from 5.5 to 7.5. The preferred neutralizing acids are hydroxycarboxylic acids such as lactic acid, salicylic acid, substituted salicylic acid such as 2-hydroxy 3-methyl benzoic acid, 2-hydroxy 4-methyl benzoic acid and mixtures of such acids. Lactic acid is most preferred.

The sucrose-based polyether polyol is included in the foam-forming mixture in an amount of up to 20%, based on the polyol blend, more preferably from 5 to 20%. The sucrose-based polyether polyol preferably has a hydroxyl number of from 250 to 550 and a functionality of from 3 to 7.

Isocyanate

Any of the known organic isocyanates may be used in the foams of the present invention. Suitable isocyanates include, but are not limited to, aromatic, aliphatic, and cycloaliphatic polyisocyanates and combinations thereof. Some examples of useful isocyanates are: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and its isomers, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenyl-methane-2,2′,5,5′-tetraisocyanate and the polymethylene polyphenylpolyisocyanates.

Undistilled or a crude polyisocyanate may also be used in making the polyurethane foams of the present invention. The crude toluene diisocyanate obtained by phosgenating a mixture of toluene diamines and the crude diphenylmethane diisocyanate obtained by phosgenating crude diphenylmethanediamine are examples of suitable crude polyisocyanates. Suitable undistilled or crude polyisocyanates are disclosed in U.S. Pat. No. 3,215,652.

Preferred polyisocyanates for the production of rigid polyurethanes of the present invention are methylene-bridged polyphenyl polyisocyanates and prepolymers of methylene-bridged polyphenyl polyisocyanates.

The isocyanate is used in an amount such that the isocyanate index (i.e., the ratio of equivalents of isocyanate groups to equivalents of isocyanate-reactive groups) is from 0.9 to 2.5, more preferably from 1.0 to 1.5. The isocyanate has an average functionality of from 2.0 to 3.2, more preferably from 2.2 to 3.0 isocyanate moieties per molecule and an NCO content of from 25 to 35% by weight.

Blowing Agent

The foams of the present invention preferably utilize from 10 to 15%, more preferably 12.5%, based on the total foam formulation, of 1,1,1,3,3-pentafluoropropane (HFC-245fa) alone as the physical blowing agent. However, small amounts of water, i.e., from 0.1 to 1.5%, based on the total foam formulation, may optionally be used in the foam forming mixture as a reactive blowing agent.

Catalyst

Any of the catalysts known to those skilled in the art for the production of rigid polyurethane foams may be employed in the process of the present invention. Examples of suitable catalysts include, but are not limited to, the amine catalysts pentamethyldiethylenetriamine, N-N-dimethylcyclohexylamine, N,N′,N″-dimethylamino-propylhexahydrotriazine, tetramethyl ethylenediamine, N,N-dimethyl cyclohexyl amine, pentamethyl diethylene triamine, and N,N′,N″-tris(3-dimethyl aminopropyl)hexahydro-S-triazine. Also suitable are organometallic, preferably organotin catalysts. Examples of suitable tin catalysts include, but are not limited to, tin (II) acetate, tin (II) octanoate, tin (II) laurate, dialkyl tin diacetates, and dibutyl tin dichloride. Potassium octanoate is also a suitable catalyst for use in the present invention. Tertiary amine catalysts are particularly preferred.

Additives

Any of the additives and processing aids typically included in the polyol component of a foam-forming mixture may, of course, be added to the polyol blend of the present invention prior to producing a rigid polyurethane foam. Examples of such suitable additives and processing aids include, but are not limited to, chain extenders, crosslinking agents, surfactants, foam stabilizers, cell regulators, fillers, dyes, pigments, flame retardants, hydrolysis protection agents, fungicides and bactericides.

As is known to those skilled in the art, the cell gas composition of the foam at the moment of manufacture does not necessarily correspond to the equilibrium gas composition after aging or sustained use. The gas in a closed cell foam frequently exhibits compositional changes as the foam ages leading to such known phenomena as increase in thermal conductivity or loss of insulation value (both measured in terms of k-factor) and thermal aging. K-factor is the rate of transfer of heat through one square foot of one inch thick material in one hour where there is a difference of one degree Fahrenheit perpendicularly across the two surfaces of the material. The k-factors of the foams of the examples herein are initial k-factors, measured at 35° F. and 75° F. soon after the foam was made and cut.

The present invention is further illustrated, but is not to be limited, by the following examples.

### EXAMPLES

In the examples below, the following materials were used:

| | |
|---|---|
| POLYOL A | A polyether polyol prepared by alkoxylating a sucrose, |
| | propylene glycol and water starter having an OH |
| | number of about 470 mg KOH/g and a functionality of |
| | about 5.2 that is commercially available from Bayer |
| | Polymers LLC as MULTRANOL 9196; |
| POLYOL B | An aromatic polyester polyol blend having an OH |
| | number of about 240 mg KOH/g and a functionality of |
| | about 2.0 that is commercially available from Stepan |
| | Company as STEPANPOL PS 2502A; |
| POLYOL C | An aromatic amine-initiated polyether polyol having |
| | an OH number of about 390 mg KOH/g and a |
| | functionality of about 4 that is commercially available |
| | from Bayer Polymers LLC as MULTRANOL 8114; |
| ISOCYANATE | a modified polymeric methylenediphenyl diisocyanate |
| | (pMDI) with an NCO content of about 30.5% and a |
| | 25° F. viscosity of about 340 mPa.s available |
| | commercially from Bayer Polymers LLC as |
| | MONDUR 1515; |
| CATALYST A | N,N′,N″-tris(3-dimethylaminopropyl)-hexahydro-S- |
| | triazine commercially available from Air Products as |
| | POLYCAT 41; |
| CATALYST B | Pentamethyldiethylenetriamine commercially available |
| | from Rhein Chemie as DESMORAPID PV; |
| SURFACTANT | a silicone surfactant commercially available from Air |
| | Products as DABCO DC 5357; |
| HFC-245fa | 1,1,1,3,3-pentafluoropropane, commercially |
| | available from Honeywell International Inc. |
| | as ENOVATE 3000. |

### Examples 1-12

In each formulation detailed below in Table I, the isocyanate index was kept constant so that the amount of isocyanate used increased with the hydroxyl number of the polyol. The total amounts of water and HFC-245fa in the foam formulation were kept constant so that each foam would have the same cell gas content and total amount of blowing. The catalyst level for each example was adjusted to give a gel time of about 50±5 seconds.

All foams were prepared by hand-mixing a pre-blended masterbatch containing the polyol blend, blowing agent, water and additives with the isocyanate (both the masterbatch and the isocyanate were at 10° C.) and pouring the resultant mixture into a 2 in. thick by 13 in. wide by 24 in. tall mold which was maintained at 120° F. The minimum fill density of the formulation was determined and three panels at 10% overpack were prepared and tested for k-factor. K-factors were measured on the center core section (8 in.×8 in.×1 in.) at 35° F. (2° C.) and at 75° F. (24° C.) on a LASERCOMP FOX 200 instrument. Table I summarizes the results of the above-detailed examples.

As is apparent by reference to Table I, foams made with the inventive polyol blends having 20% or less of a sucrose-based polyether polyol as part of the polyol blend (Examples 10 and 11) achieve comparably low k-factors while using reduced amounts of the aromatic polyester and aromatic amine-initiated polyether polyols. Surprisingly, polyol blends containing only an aromatic polyester polyol and an aromatic amine-initiated polyether polyol (i.e., Examples 6 and 7) can also be used to prepare rigid foam with low k-factors. From Example 1, one skilled in the art can appreciate that an aromatic amine-initiated polyether polyol alone may also be used to prepare a rigid foam with a low k-factor.

TABLE I

| | Ex. No. | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Blend components | % | % | % | % | % | % | % | % | % | % | % | % |
| Polyol A | 0 | 27.4 | 80 | 80 | 40 | 0 | 0 | 60 | 60 | 20 | 18 | 50 |
| Polyol B | 0 | 0 | 0 | 20 | 60 | 60 | 20 | 14 | 40 | 44 | 51 | 30 |
| Polyol C | 100 | 72.6 | 20 | 0 | 0 | 40 | 80 | 26 | 0 | 36 | 31 | 20 |
| Polyol Blend | 34.25 | 33.22 | 31.23 | 32.39 | 37.26 | 39.26 | 35.80 | 32.93 | 34.77 | 36.85 | 37.46 | 34.49 |
| Surfactant | 1.43 | 1.43 | 1.42 | 1.42 | 1.43 | 1.43 | 1.43 | 1.43 | 1.43 | 1.43 | 1.45 | 1.34 |
| Catalyst A | 0.57 | 0.50 | 0.84 | 0.86 | 0.47 | 0.43 | 0.48 | 0.58 | 0.53 | 0.46 | 0.51 | 0.52 |
| Catalyst B | 0.28 | 0.25 | 0.42 | 0.43 | 0.23 | 0.22 | 0.24 | 0.29 | 0.26 | 0.23 | 0.25 | 0.26 |
| Water | 0.46 | 0.46 | 0.45 | 0.46 | 0.45 | 0.46 | 0.45 | 0.45 | 0.46 | 0.46 | 0.46 | 0.45 |
| HFC-245fa | 12.45 | 12.48 | 12.38 | 12.47 | 12.47 | 12.48 | 12.46 | 12.43 | 12.45 | 12.47 | 12.51 | 12.45 |
| Total | 49.45 | 48.34 | 46.75 | 48.03 | 52.32 | 54.27 | 50.87 | 48.12 | 49.90 | 51.90 | 52.63 | 49.52 |
| Isocyanate | 50.55 | 51.66 | 53.25 | 51.97 | 47.68 | 45.73 | 49.13 | 51.88 | 50.10 | 48.10 | 47.37 | 50.48 |
| Total Foam | 100.00 | 100.00 | 100.00 | 100.00 | 100.00 | 100.00 | 100.00 | 100.00 | 100.00 | 100.00 | 100.00 | 100.00 |
| Gel Time (s) | 48 | 54 | 51 | 49 | 51 | 48 | 48 | 53 | 54 | 52 | 52 | 55 |
| 35° F. k-factor | 0.115 | 0.118 | 0.122 | 0.122 | 0.117 | 0.115 | 0.115 | 0.118 | 0.119 | 0.116 | 0.118 | 0.121 |
| (BTU-in./hr · ft² ° F.) | | | | | | | | | | | | |
| 75° F. k-factor | 0.130 | 0.134 | 0.138 | 0.138 | 0.133 | 0.130 | 0.130 | 0.134 | 0.135 | 0.131 | 0.133 | 0.140 |
| (BTU-in./hr · ft² ° F.) | | | | | | | | | | | | |

The inventive rigid polyurethane foams are particularly suitable as insulation materials in the construction and refrigeration industries. Foam laminates of rigid polyurethane foam of the present invention may be useful for residential sheathing (with aluminum skins) and roofing board (with roofing-paper skins). A foam-in-place process can be used to insulate metal doors and for appliance insulation. Rigid polyurethane according to the present invention may also be used as insulation for water heaters, refrigerated truck trailers' bodies, and rail cars.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A rigid polyurethane foam prepared by mixing:
an isocyanate;
a polyol blend comprising
about 20% to about 100%, based on the total polyol blend, of an aromatic amine-initiated polyether polyol,
up to about 60%, based on the total polyol blend, of an aromatic polyester polyol, and
up to about 20%, based on the total polyol blend, of a sucrose-based polyether polyol,
wherein the sum of the percentages of the polyols totals 100%; and
about 10 to about 15%, based on the total foam formulation, of 1,1,1,3,3-pentafluoropropane (HFC-245fa),
optionally, one or more components chosen from catalysts, chain extenders, crosslinking agents, surfactants, foam stabilizers, cell regulators, fillers, dyes, pigments, flame retardants, hydrolysis protection agents, fungicides and bactericides,
wherein the rigid polyurethane foam has a k-factor at 35° F. of from about 0.115 to about 0.120 BTU-in./hr.ft²° F.

2. The rigid polyurethane foam according to claim 1, wherein the polyol blend comprises about 55% of the aromatic amine-initiated polyether polyol, about 25% of the aromatic polyester polyol and about 20% of the sucrose-based polyether polyol.

3. The rigid polyurethane foam according to claim 1, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

4. The rigid polyurethane foam according to claim 1, wherein the isocyanate is a modified polymeric methylenediphenyl diisocyanate (pMDI).

5. The rigid polyurethane foam according to claim 1, wherein the foam formulation further includes from about 0.1% to about 1.5%, based on the total foam formulation of water.

6. The rigid polyurethane foam according to claim 1, wherein the aromatic amine-initiated polyol is based on ortho-toluene diamine (o-TDA).

7. The rigid polyurethane foam according to claim 1, wherein the foam formulation comprises about 12.5%, based on the total foam formulation, of the 1,1,1,3,3-pentafluoropropane (HFC-245fa).

8. In a process of making an appliance insulation material, the improvement comprising including the rigid polyurethane foam according to claim 1.

9. A rigid polyurethane foam prepared by mixing:
an isocyanate;
a polyol blend comprising
about 20% to about 90%, based on the total polyol blend, of the aromatic amine-initiated polyether polyol,
about 5% to about 60%, based on the total polyol blend, of the aromatic polyester polyol, and
about 5% to about 20%, based on the total polyol blend, of the sucrose-based polyether polyol,
wherein the sum of the percentages of the polyols totals 100%, and
about 10 to about 15%, based on the total foam formulation, of 1,1,1,3,3-pentafluoropropane (HFC-245fa),
optionally, one or more components chosen from catalysts, chain extenders, crosslinking agents, surfactants, foam stabilizers, cell regulators, fillers, dyes, pigments, flame retardants, hydrolysis protection agents, fungicides and bactericides,
wherein the rigid polyurethane foam has a k-factor at 35° F. of from about 0.115 to about 0.120 BTU-in./hr.ft²° F.

10. The rigid polyurethane foam according to claim 9, wherein the polyol blend comprises about 55% of the aromatic amine-initiated polyether polyol, about 25% of the aromatic polyester polyol and about 20% of the sucrose-based polyether polyol.

11. The rigid polyurethane foam according to claim 9, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

12. The rigid polyurethane foam according to claim 9, wherein the isocyanate is a modified polymeric methylenediphenyl diisocyanate (pMDI).

13. The rigid polyurethane foam according to claim 9, wherein the foam formulation further includes from about 0.1% to about 1.5%, based on the total foam formulation of water.

14. The rigid polyurethane foam according to claim 9, wherein the aromatic amine-initiated polyol is based on ortho-toluene diamine (o-TDA).

15. The rigid polyurethane foam according to claim 9, wherein the foam formulation comprises about 12.5%, based on the total foam formulation, of the 1,1,1,3,3-pentafluoropropane (HFC-245fa).

16. In a process % of making an appliance insulation material, the improvement comprising including the rigid polyurethane foam according to claim 9.

17. A rigid polyurethane foam prepared by mixing:
an isocyanate;
a polyol blend comprising
about 40% to about 90%, based on the total polyol blend, of an aromatic amine-initiated polyether polyol,
about 60% to about 10%, based on the total polyol blend, of an aromatic polyester polyol, and
wherein the sum of the percentages of the polyols totals 100%; and
about 10 to about 15%, based on the total foam formulation, of 1,1,1,3,3-pentafluoropropane (HFC-245fa),
optionally, one or more components chosen from catalysts, chain extenders, crosslinking agents, surfactants, foam stabilizers, cell regulators, fillers, dyes, pigments, flame retardants, hydrolysis protection agents, fungicides and bactericides,
wherein the rigid polyurethane foam has a k-factor at 35° F. of from about 0.115 to about 0.120 BTU-in./hr.ft²° F.

18. The rigid polyurethane foam according to claim 17, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

19. The rigid polyurethane foam according to claim 17, wherein the isocyanate is a modified polymeric methylenediphenyl diisocyanate (pMDI).

20. The rigid polyurethane foam according to claim 17, wherein the foam formulation further includes from about 0.1% to about 1.5%, based on the total foam formulation, of water.

21. The rigid polyurethane foam according to claim 17, wherein the aromatic amine-initiated polyol is based on ortho-toluene diamine (o-TDA).

22. The rigid polyurethane foam according to claim 17, wherein the polyol blend further includes up to about 20%, based on the total polyol blend, of a sucrose-based polyether polyol.

23. The rigid polyurethane foam according to claim 17, wherein the foam formulation comprises about 12.5%, based on the total foam formulation, of the 1,1,1,3,3-pentafluoropropane (HFC-245fa).

24. In a process of making an appliance insulation material, the improvement comprising including the rigid polyurethane foam according to claim 17.

25. A process for making a rigid polyurethane foam comprising mixing:
an isocyanate;
a polyol blend comprising
about 20% to about 100%, based on the total polyol blend, of an aromatic amine-initiated polyether polyol,
up to about 60%, based on the total polyol blend, of an aromatic polyester polyol, and
up to about 20%, based on the total polyol blend, of a sucrose-based polyether polyol,
wherein the sum of the percentages of the polyols totals 100%; and
about 10 to about 15%, based on the total foam formulation, of 1,1,1,3,3-pentafluoropropane (HFC-245fa),
optionally, one or more components chosen from chain extenders, crosslinking agents, surfactants, foam stabilizers, cell regulators, fillers, dyes, pigments, flame retardants, hydrolysis protection agents, fungicides and bactericides,
optionally in the presence of a catalyst,
wherein the rigid polyurethane foam has a k-factor at 35° F. of from about 0.115 to about 0.120 BTU-in./hr.ft²° F.

26. The process according to claim 25, wherein the polyol blend comprises about 55% of the aromatic amine-initiated polyether polyol, about 25% of the aromatic polyester polyol and about 20% of the sucrose-based polyether polyol.

27. The process according to claim 25, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

28. The process according to claim 25, wherein the isocyanate is a modified polymeric methylenediphenyl diisocyanate (pMDI).

29. The process according to claim 25, wherein from about 0.1% to about 1.5%, based on the total foam formulation, of water is included.

30. The process according to claim 25, wherein the aromatic amine-initiated polyol is based on ortho-toluene diamine (o-TDA).

31. The process according to claim 25, wherein the foam formulation comprises about 12.5%, based on the total foam formulation, of the 1,1,1,3,3-pentafluoropropane (HFC-245fa).

32. In a process of making an appliance insulation material, the improvement comprising including the rigid polyurethane foam made by the process according to claim 25.

33. A process for making a rigid polyurethane foam comprising mixing:
an isocyanate;
a polyol blend comprising
about 20% to about 90%, based on the total polyol blend, of the aromatic amine-initiated polyether polyol,
about 5% to about 60%, based on the total polyol blend, of the aromatic polyester polyol, and
about 5% to about 20%, based on the total polyol blend, of the sucrose-based polyether polyol,
wherein the sum of the percentages of the polyols totals 100%; and
about 10 to about 15%, based on the total foam formulation, of 1,1,1,3,3-pentafluoropropane (HFC-245fa),
optionally, one or more components chosen from chain extenders, crosslinking agents, surfactants, foam stabilizers, cell regulators, fillers, dyes, pigments, flame retardants, hydrolysis protection agents, fungicides and bactericides,
optionally in the presence of a catalyst,
wherein the rigid polyurethane foam has a k-factor at 35° F. of from about 0.115 to about 0.120 BTU-in./hr.ft²° F.

34. The process according to claim 33, wherein the polyol blend comprises about 55% of the aromatic amine-initiated polyether polyol, about 25% of the aromatic polyester polyol and about 20% of the sucrose-based polyether polyol.

35. The process according to claim 33, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

36. The process according to claim 33, wherein the isocyanate is a modified polymeric methylenediphenyl diisocyanate (pMDI).

37. The process according to claim 33, wherein from about 0.1% to about 1.5%, based on the total foam formulation, of water is included.

38. The process according to claim 33, wherein the aromatic amine-initiated polyol is based on ortho-toluene diamine (o-TDA).

39. The process according to claim 33, wherein the foam formulation comprises about 12.5%, based on the total foam formulation, of the 1,1,1,3,3-pentafluoropropane (HFC-245fa).

40. In a process of making an appliance insulation material, the improvement comprising including the rigid polyurethane foam made by the process according to claim 33.

41. A process for making a rigid polyurethane foam comprising mixing:
an isocyanate;
a polyol blend comprising
about 40% to about 90%, based on the total foam formulation, of an aromatic amine-initiated polyether polyol,
about 60% to about 10%, based on the total foam formulation, of an aromatic polyester polyol, and
wherein the sum of the percentages of the polyols totals 100%; and
about 10 to about 15%, based on the total foam formulation, of 1,1,1,3,3-pentafluoropropane (HFC-245fa),
optionally, one or more components chosen from catalysts, chain extenders, crosslinking agents, surfactants, foam stabilizers, cell regulators, fillers, dyes, pigments, flame retardants, hydrolysis protection agents, fungicides and bactericides,
wherein the rigid polyurethane foam has a k-factor at 35° F. of from about 0.115 to about 0.120 BTU-in./hr.ft²° F.

42. The process according to claim 41, wherein the isocyanate is chosen from m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and isomers thereof, 1,5-naphthylene diisocyanate, 1-methyl-phenyl-2,4-phenyl diisocyanate, 4,4′-diphenylmethane diisocyanate, 2,4′-diphenyl-methane diisocyanate, 4,4′-biphenylene diisocyanate, 3,3′-dimethoxy-4,4′-biphenylene diisocyanate, 3,3′-dimethyl-diphenyl-propane-4,4′-diisocyanate, 2,4,6-toluene triisocyanate, 4,4′-dimethyl-diphenyl-methane-2,2′,5,5′-tetraisocyanate and polymethylene polyphenylpolyisocyanates.

43. The process according to claim 41, wherein the isocyanate is a modified polymeric methylenediphenyl diisocyanate (pMDI).

44. The process according to claim 41, wherein from about 0.1% to about 1.5%, based on the total foam formulation, of water is included.

45. The process according to claim 41, wherein the aromatic amine-initiated polyol is based on ortho-toluene diamine (o-TDA).

46. The process according to claim 41, wherein the foam formulation comprises about 12.5%, based on the total foam formulation, of the 1,1,1,3,3-pentafluoropropane (HFC-245fa).

47. The process according to claim 41, wherein the polyol blend further includes up to about 20%, based on the total foam formulation, of a sucrose-based polyether polyol.

48. In a process of making an appliance insulation material, the improvement comprising including the rigid polyurethane foam made by the process according to claim 41.
